(19) United States
(12) Patent Application Publication
(10) Pub. No.: US 2025/0108745 A1
(43) Pub. Date: Apr. 3, 2025

(54) Ergonomic Elevated Foot Board Device for Vehicles with a Floor Mounted Pedal or Pedals

(71) Applicant: NITEWORKS LLC, Charlotte, NC (US)

(72) Inventor: Thornnie Rouse, Mooresville, NC (US)

(73) Assignee: NITEWORKS LLC, Charlotte, NC (US)

(21) Appl. No.: 18/894,033

(22) Filed: Sep. 24, 2024

Related U.S. Application Data
(60) Provisional application No. 63/541,931, filed on Oct. 2, 2023.

(51) Int. Cl. B60N 3/06; B60N 3/04

(52) U.S. Cl. CPC B60N 3/06; B60N 3/046

(57) ABSTRACT

An ergonomic elevated foot board device for a vehicle with a driver's seat with a seat base mount, a steering wheel with a steering column, and a floorboard includes a main base with a top surface. The main base includes a first cutout on a back side of the main base and a second cutout on the front side of the main base. The first cutout is configured to fit around the seat base mount of the driver's seat of the vehicle. The second cutout is configured to fit around the steering column of the steering wheel of the vehicle. Wherein, when the main base is positioned with the first cutout around the seat base mount and the second cutout around the steering column, the ergonomic elevated foot board device is configured to position the top surface at an elevated position above the floorboard.

### CROSS-REFERENCE TO RELATED APPLICATIONS

This application claims benefit to U.S. Provisional Patent Application No. 63/541,931, filed on Oct. 2, 2023, which is incorporated by reference in its entirety.

### FIELD OF THE DISCLOSURE

The present disclosure is related to ergonomic device for vehicles, like motor coaches, buses, trucks, or the like. More precisely, the present disclosure is directed to an ergonomic elevated foot board device for vehicles with a floor mounted pedal or pedals, like a motor coach, a bus, a truck, or the like.

### BACKGROUND

Generally speaking, automobile controls are the components in automobiles and other powered road vehicles, such as trucks and buses, used for driving and parking. Controls like steering wheels and pedals have existed since the invention of cars, other controls have developed and adapted to the demands of drivers. Pedals control the braking and acceleration of the vehicle, and can control the clutch for vehicles with manual transmissions. Pedals either hang from the bulkhead or stand on the floor and the arrangement is the same for both right-hand and left-hand traffic. The instant disclosure may be directed for use with vehicles with floor mounted pedals, but is not limited thereto, and may be used for vehicles with other pedal arrangements.

One problem the instant disclosure recognizes is that floor mounted pedals require the driver to lift the front of their foot off the floorboard to operate the floor mounted pedal. This need of the driver to lift the front of their foot off the ground to operate the pedal may result in some less than smooth operation of the vehicle, especially for less experienced drivers of the vehicle. In addition, the need of the driver to lift the front of their foot off the ground to operate the pedal creates fatigue in the leg and ankles of the driver, especially on longer trips, like commonly taken on motor coaches, buses, trucks, or the like. As such, there is clearly a need to provide a more ergonomic means or method for operating such vehicles with floor mounted pedals.

The instant disclosure may be designed to address at least certain aspects of the problems or needs discussed above by providing an ergonomic elevated foot board device for vehicles with a floor mounted pedal or pedals, like a motor coach, a bus, a truck, or the like.

### SUMMARY

The present disclosure may solve the aforementioned limitations of the currently available means and method for operating floor mounted pedals, like pedals in motorcoaches, buses, trucks, or the like, by providing an ergonomic elevated foot board device for vehicles with a floor mounted pedal or pedals, like a motor coach, a bus, a truck, or the like.

Accordingly, in one aspect, the present disclosure embraces an ergonomic elevated foot board device for a vehicle, where the vehicle may include a driver's seat with a seat base mount, a steering wheel with a steering column, and a floorboard under the driver's seat and the steering column. The ergonomic elevated foot board device may generally include a main base with a top surface. The main base may include a first cutout on a back side of the main base. The first cutout may be configured to fit around the seat base mount of the driver's seat of the vehicle. The main base may also include a second cutout on the front side of the main base. The second cutout may be configured to fit around the steering column of the steering wheel of the vehicle. Wherein, when the main base is positioned in between the driver's seat and the steering column of the vehicle with the first cutout around the seat base mount and the second cutout around the steering column, the ergonomic elevated foot board device may be configured to position the top surface at an elevated position above the floorboard between the driver's seat and the steering column.

One feature of the disclosed ergonomic elevated foot board device may be that it can be designed and configured to minimize foot or ankle soreness of the driver when operating a floor mounted pedal or pedals in the vehicle.

In select embodiments of the disclosed ergonomic elevated foot board device, the first cutout may include a first width. The first width may be sized to receive the seat base mount therein.

In select embodiments of the disclosed ergonomic elevated foot board device, the second cutout may include a second width. The second width may be configured to receive the steering column therein.

In other select embodiments of the disclosed ergonomic elevated foot board device, the first cutout may include a first depth, the second cutout may include a second depth, the main base may include a length from the front side to the back side, and the main base may include a cutout distance from a first end of the first cutout at the first depth to a second end of the second cutout at the second depth. The cutout distance may be approximate to a driver's foot area distance between the seat base mount and the steering column.

In other select embodiments of the disclosed ergonomic elevated foot board device, the main base may include a platform structure and elevating members. The platform structure may have the top surface thereon. The elevating members may be positioned under the platform structure. The elevating members may be configured to elevate the platform structure from the floorboard of the vehicle and to serve as a foundation of the platform structure on the floorboard.

In select embodiments of the disclosed ergonomic elevated foot board device, the platform structure may include the first cutout on the back side of the main base and the second cutout in the front side of the main base.

In select embodiments of the disclosed ergonomic elevated foot board device, the platform structure may further include a pedal notch on the front side of the main base. Wherein, when the main base is positioned in between the driver's seat and the steering column of the vehicle with the first cutout around the seat base mount and the second cutout around the steering column, the pedal notch may be configured to be positioned approximate a floor mounted pedal.

In select embodiments of the disclosed ergonomic elevated foot board device, the platform structure may be made from a wood material, a sheet metal material, or a hard plastic material. The sheet metal material may be, but is not limited to, a 16-guage aluminum sheet metal material approximately 2 feet by 2 feet. The hard plastic material may be, but is not limited to, a polyethylene hard plastic material.

In select embodiments of the disclosed ergonomic elevated foot board device, the platform structure may include an edge guard. The edge guard may be around a perimeter of the platform structure. The edge guard may be, but is not limited to, a rubber guard positioned on the perimeter of the platform structure. In select embodiments, the edge guard may be form-fitting on the perimeter of the platform structure. In other select embodiments, the edge guard may be permanently affixed to the perimeter of the platform structure, like with a commercial grade adhesive.

In select embodiments of the disclosed ergonomic elevated foot board device, the top surface of the platform structure may include a rubber grip surface on the top surface, a coated or sprayed grip on the top surface, a textured surface being the top surface, a padded heel rest on the top surface, a carpeted surface, the like, and/or combinations thereof. The carpeted surface may be attached on the top surface via a hook and loop type fastener. Wherein the carpeted surface may be configured to be removable.

In select embodiments of the disclosed ergonomic elevated foot board device, the elevating members may include a left side elevating member and a right side elevating member. The left side elevating member may be affixed on a bottom side of the platform structure approximate a left side of the platform structure. The right side elevating member may be affixed on the bottom side of the platform structure approximate a right side of the platform structure. Wherein the left side elevating member and the right side elevating member may include a height. The height of the left side elevating member and the right side elevating member may be configured to elevate the platform structure to the elevated position. In select embodiments, the height of the left side elevating member and the right side elevating member may be, but is clearly not limited thereto, approximately 2 inches configured to elevate the platform structure approximately 2 inches. In select embodiments, the left side elevating member and the right side elevating member may each be a 2 inch by 2 inch square aluminum tube with plastic end caps on each end (for appearance and/or safety).

One feature of the disclosed ergonomic elevated foot board device may be the inclusion of base protectors on a bottom portion of the left side elevating member and the right side elevating member. The base protectors may be configured to provide a barrier between the elevating members and the floorboard and may be configured to protect the floorboard from damage. In select embodiments, the base protectors may be, but are not limited to, ribbed rubber stripping. Wherein, the ribbed rubber stripping may be self-adhering or may be permanently affixed, like with commercial grade adhesive, to the bottom portion of the elevating members.

In select embodiments of the disclosed ergonomic elevated foot board device, the elevating members may include at least one bracing member. The at least one bracing member may be between the left side elevating member and the right side elevating member. The at least one bracing member may be configured to reinforce and stabilize the platform structure on the elevating members. In select embodiments, the at least one bracing member may include a front cross member, a rear cross member, and an interconnecting member. The front cross member may be positioned approximate the front side of the main base. The rear cross member may be positioned approximate the back side of the main base. The interconnecting member may be interconnected between the front cross member and the rear cross member. In select embodiments, a first extension member and a second extension member may be included. The first extension member may extend from the rear cross member on a first side of the first cutout. The second extension member may extend from the rear cross member on a second side of the first cutout. In select embodiments, each of the at least one bracing members may be a one inch by one inch square aluminum tube with caps on any open ends (like for appearance and/or safety).

Another feature of the disclosed ergonomic elevated foot board device may be the inclusion of a handle. The handle may be configured to be used to carry the ergonomic elevated foot board device. In select embodiments, the handle may be positioned on an outside side of a left side elevating member or a right side elevating member.

Another feature of the disclosed ergonomic elevated foot board device may be that it can be configured for a motorcoach, a bus, a truck, the like, and/or combinations thereof.

In another aspect, the present disclosure embraces the disclosed ergonomic elevated foot board device in any of the various embodiments and/or combination of embodiments shown and/or described herein.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present apparatuses, systems and methods will be better understood by reading the disclosure with reference to the accompanying drawings, which are not necessarily drawn to scale, and in which like reference numerals denote similar structure and refer to like elements throughout, and in which:

FIG. 1 is a top, back, right perspective view of the ergonomic elevated foot board device for vehicles with a floor mounted pedal or pedals according to select embodiments of the instant disclosure;

FIG. 2 is a bottom, back, left perspective view of the ergonomic elevated foot board device from FIG. 1;

FIG. 3 is a top view of the ergonomic elevated foot board device from FIG. 1;

FIG. 4 is a bottom view of the ergonomic elevated foot board device from FIG. 1;

FIG. 5 is a bottom, back, right perspective view of the ergonomic elevated foot board device from FIG. 1;

FIG. 6 is a back view of the ergonomic elevated foot board device from FIG. 1;

FIG. 7 is a front view of the ergonomic elevated foot board device from FIG. 1;

FIG. 8 is a left side view of the ergonomic elevated foot board device from FIG. 1;

FIG. 9 is a right side view of the ergonomic elevated foot board device from FIG. 1;

FIG. 10 is a left side view of a schematical representation of the ergonomic elevated foot board device for vehicles with a floor mounted pedal or pedals according to select embodiments of the instant disclosure installed in position between the seat base mount of a driver's seat and the steering column showing a driver in the driver's seat of the vehicle operating the floor mounted pedals while resting their foot on the ergonomic elevated foot board device;

FIG. 11 is a side perspective view of a motor coach or a bus with a zoomed in view of the driver's seat area showing the ergonomic elevated foot board device for vehicles according to select embodiments installed in position between the seat base mount of the driver's seat and the steering column; and

FIG. 12 is a side perspective view of a truck with the ergonomic elevated foot board device for vehicles according to select embodiments installed in position between the seat base mount of the driver's seat and the steering column.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

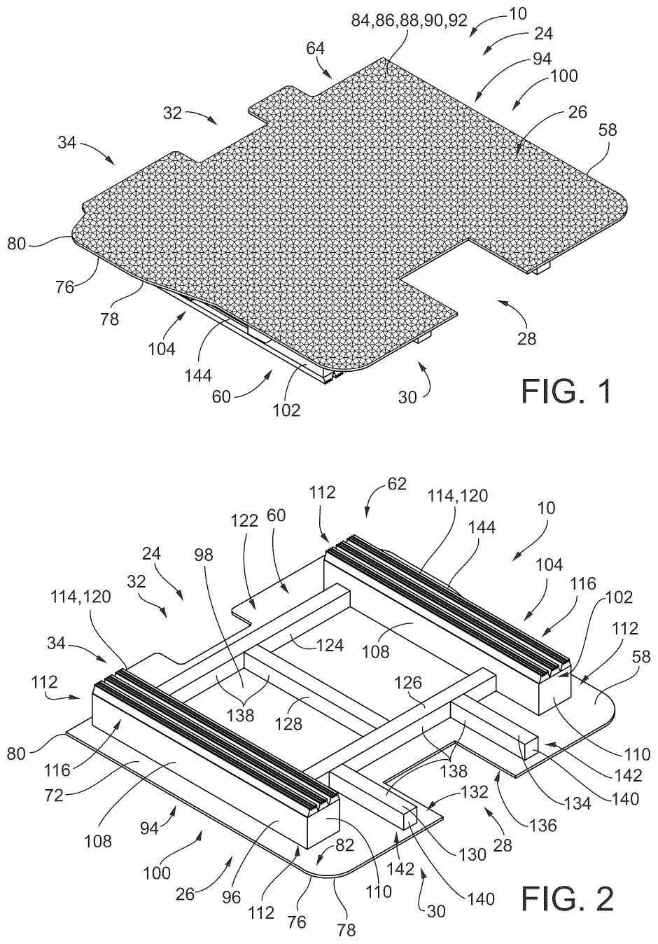

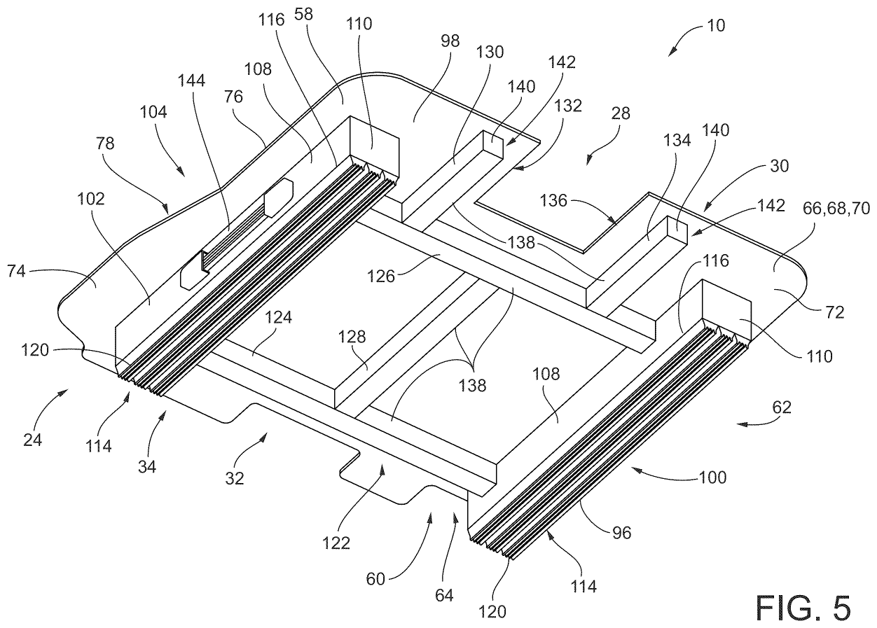

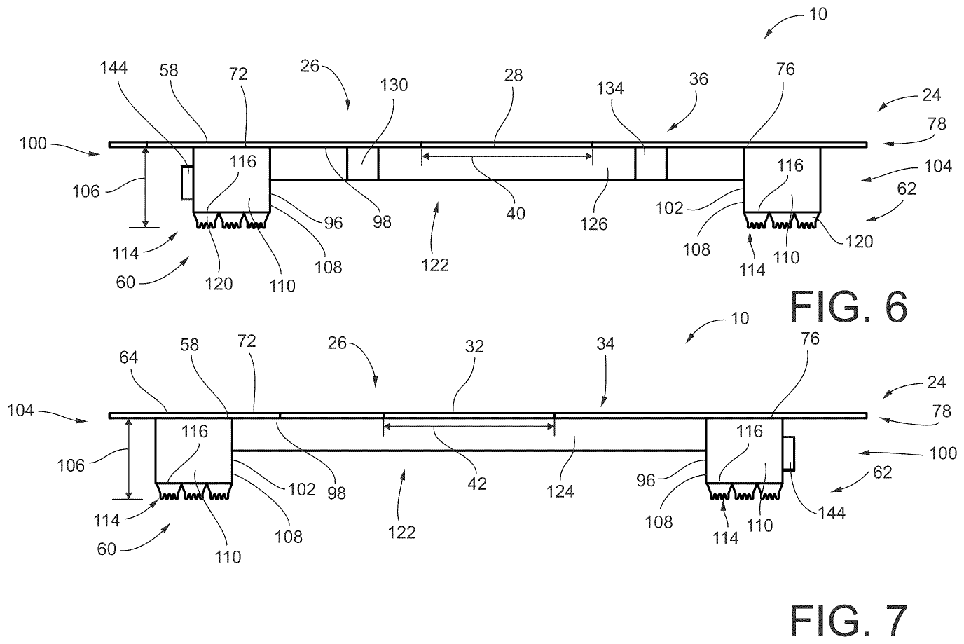

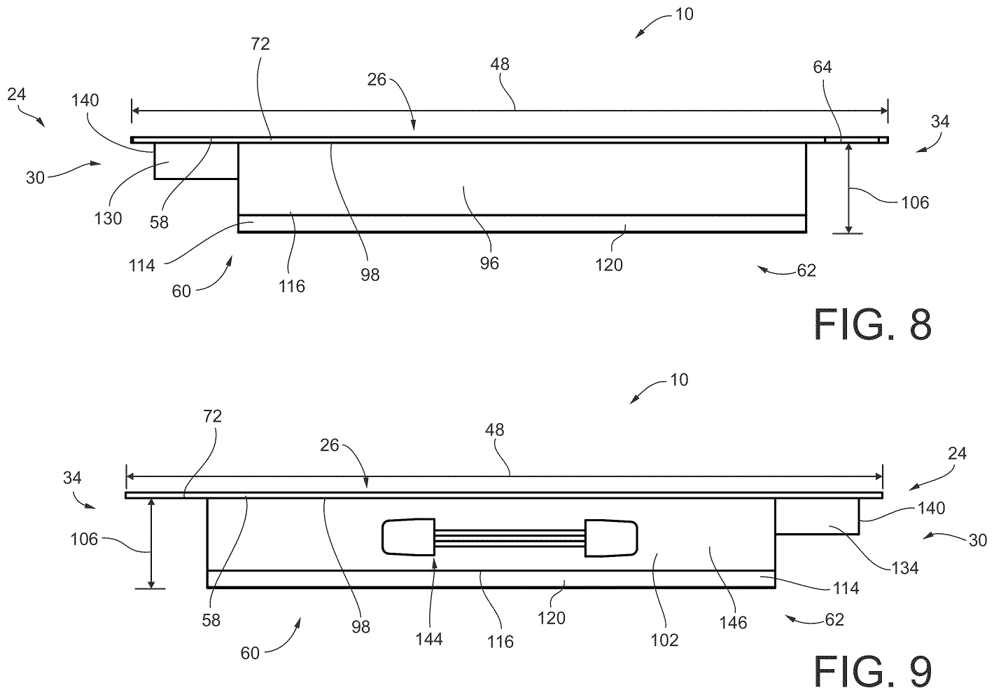

Referring now to FIGS. 1-12, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

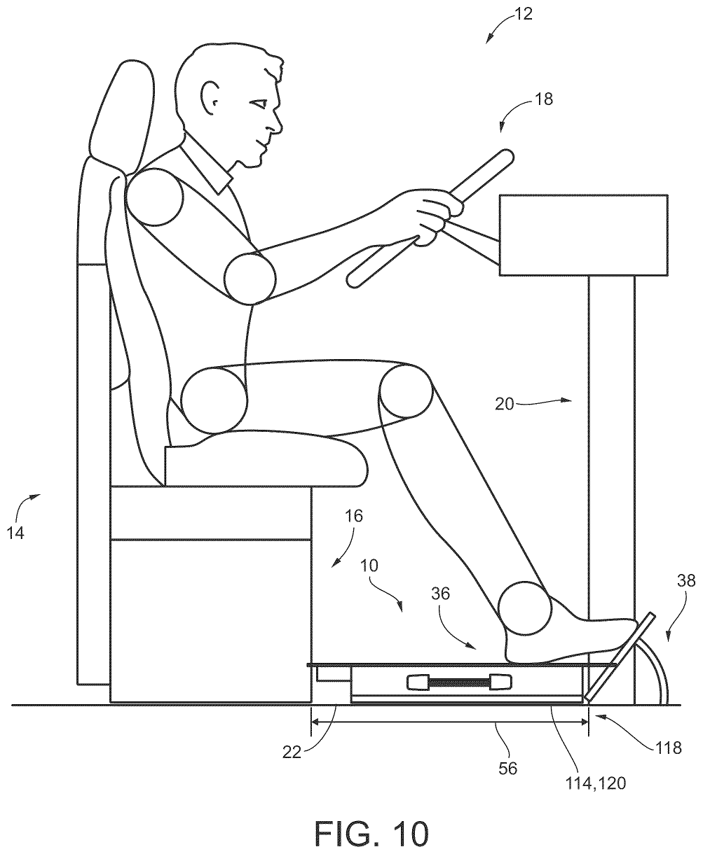

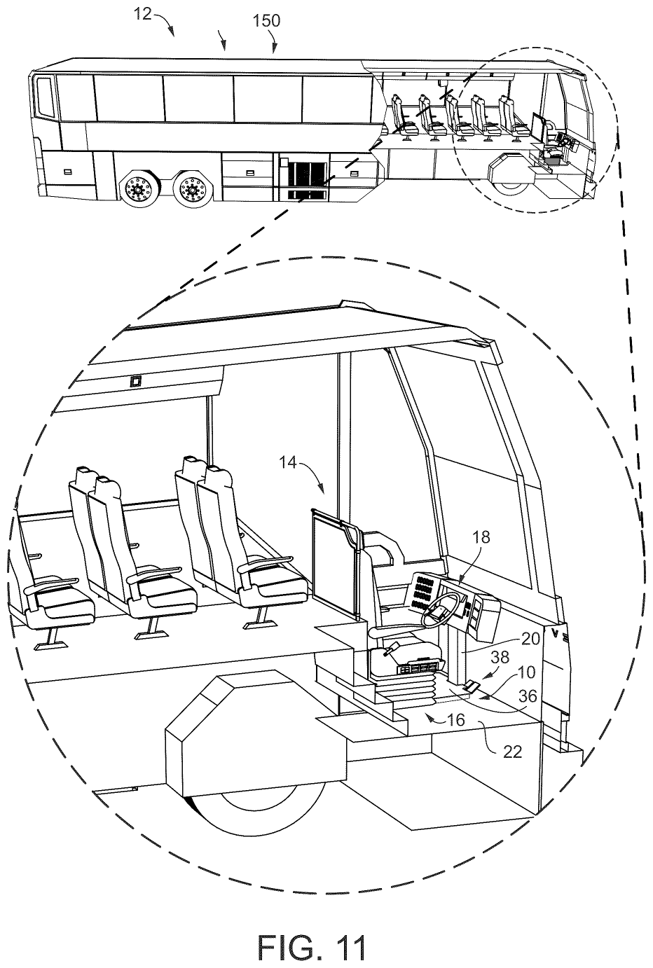

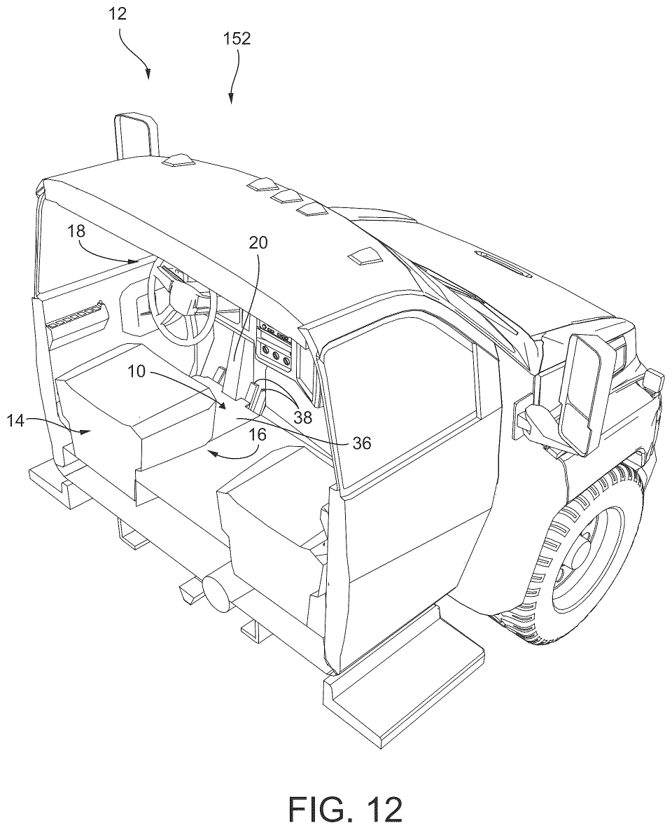

The present disclosure may solve the aforementioned limitations of the currently available means and method for operating floor mounted pedals, like pedals in motorcoaches, buses, trucks, or the like, by providing ergonomic elevated foot board device 10. Ergonomic elevated foot board device 10 may be designed and configured for, but is not limited to, vehicle 12 with floor mounted pedal 38 or pedals 38 (see FIGS. 10-12), like motor coach 148 (see FIG. 11), bus 150 (see FIG. 11), truck 152 (see FIG. 12), or the like. Ergonomic elevated foot board device 10 may be used on such vehicles 12 for reducing or eliminating any need of the driver to lift the front of their foot off the floorboard to operate the pedal 38, which may create fatigue in the leg and/or ankles of the driver, especially on longer trips, like commonly taken on motor coaches 148, buses 150, trucks 152, or the like. As examples, and clearly not limited thereto, ergonomic elevated foot board device 10 may be designed and configured for a 2013 Prevost H3-45 motorcoach, a 2005 Prevost H3-45 motorcoach, a 2024 Prevost H3-45 motorcoach, the like, etc. As such, ergonomic elevated foot board device 10 clearly provides a more ergonomic means or method for operating such vehicles 12 with floor mounted pedals 38.

Accordingly, as best shown in FIGS. 10-12, ergonomic elevated foot board device 10 may be designed and configured for vehicle 12 that includes a driver's seat 14 with seat base mount 16, steering wheel 18 with steering column 20, and floorboard 22 under the driver's seat 14 and steering column 20. When used in vehicles with this configuration, ergonomic elevated foot board device 10 may be positioned between seat base mount 16 and steering column 20 for providing an elevated platform or surface for the driver's foot.

Referring now to FIGS. 1-9, ergonomic elevated foot board device 10 may generally include main base 24 with top surface 26. Main base 24 may include first cutout 28 on back side 30 of main base 24. First cutout 28 may be configured to fit around seat base mount 16 of the driver's seat 14 of vehicle 12. Main base 24 may also include second cutout 32 on front side 34 of main base 24. Second cutout 32 may be configured to fit around steering column 20 of steering wheel 18 of vehicle 12. Wherein, when main base 24 is positioned in between the driver's seat 14 and the steering column 20 of vehicle 12 with first cutout 28 around seat base mount 16 and second cutout 32 around steering column 20, ergonomic elevated foot board device 10 may be configured to position top surface 26 at elevated position 36 above floorboard 22 between the driver's seat 14 and steering column 20 (as best shown in FIGS. 10-12).

One feature of ergonomic elevated foot board device 10 may be that it can be designed and configured to minimize foot or ankle soreness of the driver when operating floor mounted pedal 38 or pedals 38 in vehicle 12.

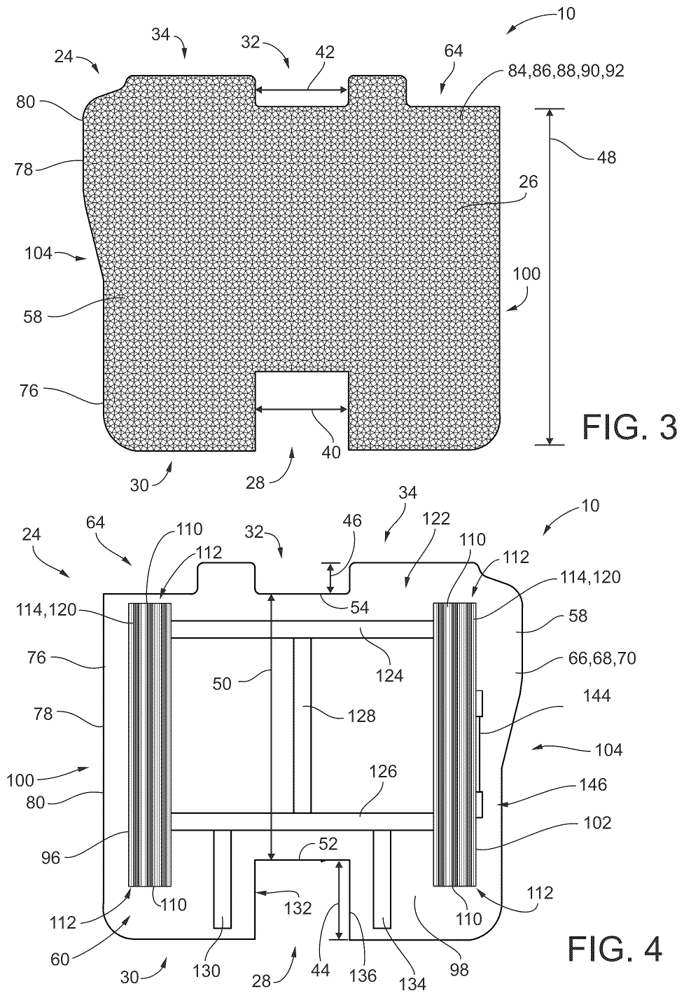

As best shown in FIG. 3, in select embodiments of ergonomic elevated foot board device 10, first cutout 28 may include first width 40. First width 40 may be any desired width of first cutout 28. In select embodiments, first width 40 may be sized to receive seat base mount 16 therein. First width 40 may be sized and configured to fit various sizes and locations of seat base mount 16 in various types of vehicles 12, including but not limited to, various models of motor coaches 148, buses 150, trucks 152, the like, or other types of vehicles 12. First width 40 may be sized slightly larger (approximately 0.001 inches to 1 inches) than the width of seat base mount 16 of vehicle 12. As such, seat base mount 16 may be utilized to maintain ergonomic elevated foot board device 10 in position under the driver's feet.

Still referring to FIG. 3, in select embodiments of ergonomic elevated foot board device 10, second cutout 32 may include second width 42. Second width 42 may be any desired width of second cutout 32. In select embodiments, second width 42 may be sized to receive steering column 20 therein. Second width 42 may be sized and configured to fit various sizes and locations of steering column 20 in various types of vehicles 12, including but not limited to, various models of motor coaches 148, buses 150, trucks 152, the like, or other types of vehicles 12. Second width 42 may be sized slightly larger (approximately 0.001 inches to 1 inches) than the width of steering column 20 of vehicle 12. As such, steering column 20 may be utilized to maintain ergonomic elevated foot board device 10 in position under the driver's feet.

As best shown in FIG. 4, in other select embodiments of ergonomic elevated foot board device 10, first cutout 28 may include first depth 44, second cutout 32 may include second depth 46, main base 24 may include length 48 from front side 34 to back side 30, and main base 24 may include cutout distance 50 from first end 52 of first cutout 28 at first depth 44 to second end 54 of second cutout 32 at second depth 46. Cutout distance 50 may be approximate to driver's foot area distance 56 between seat base mount 16 and steering column 20 (see FIG. 10). First depth 44, second depth 46, length 48 and cutout distance 50 may be sized and configured to fit various sizes and locations of seat base mount 16 and steering column 20 in various types of vehicles 12, including but not limited to, various models of motor coaches 148, buses 150, trucks 152, the like, or other types of vehicles 12.

Referring still to FIGS. 1-9, in other select embodiments of ergonomic elevated foot board device 10, main base 24 may include platform structure 58 and elevating members 60. Platform structure 58 may have top surface 26 thereon. Elevating members 60 may be positioned under platform structure 58. Elevating members 60 may be configured to elevate platform structure 58 from floorboard 22 of vehicle 12 and to serve as foundation 62 of platform structure 58 on floorboard 22. As shown in FIGS. 1-9, in select embodiments of ergonomic elevated foot board device 10, platform structure 58 may include first cutout 28 on back side 30 of main base 24 and second cutout 32 in front side 34 of main base 24.

As best shown in FIGS. 1, 3, 4 and 5, in select embodiments of ergonomic elevated foot board device 10, platform structure 58 may further include pedal notch 64. Pedal notch 64 may be on front side 34 of main base 24. Wherein, when main base 24 is positioned in between the driver's seat 14 and steering column 20 of vehicle 12 with first cutout 28 around seat base mount 16 and second cutout 32 around steering column 20, pedal notch 64 may be configured to be positioned approximate floor mounted pedal 38 or multiple floor mounted pedals 38 (like the brake pedal and/or gas pedal).

Platform structure 58 may be made from any desired material or combination of materials. In select embodiments of ergonomic elevated foot board device 10, platform structure 58 may be made from wood material 66, sheet metal material 68, hard plastic material 70, the like, any combinations thereof, as well as a myriad of other durable products. Sheet metal material 68 may be, but is not limited to, 16-guage aluminum sheet metal material 72 that may be approximately 2 feet by 2 feet, like as shown in FIGS. 1-9. Hard plastic material 70 may be, but is not limited to, polyethylene hard plastic material 74.

Still referring to FIGS. 1-9, in select embodiments of ergonomic elevated foot board device 10, platform structure 58 may include edge guard 76. Edge guard 76 may be around perimeter 78 of platform structure 58, or at least partially around perimeter 78 of platform structure 58. Edge guard 76 may be designed and configured for providing a safe edge to platform structure 58. In select embodiments, edge guard 76 may be, but is not limited to, rubber guard 80 positioned on perimeter 78 of platform structure 58. In select embodiments, edge guard 76 may be form-fitting on perimeter 78 of platform structure 58. In other select embodiments, edge guard 76 may be permanently affixed to perimeter 78 of platform structure 58, like with commercial grade adhesive 82, or the like.

Referring now specifically to FIGS. 1 and 3, in select embodiments of ergonomic elevated foot board device 10, top surface 26 of platform structure 58 may include a grip and/or comfort layer positioned thereon for providing grip and/or comfort to the driver. In select embodiments, top surface 26 of platform structure 58 may include rubber grip surface 84, coated or sprayed grip 86 on top surface 26, textured surface 88 being top surface 26, padded heel rest 90 on top surface 26, carpeted surface 92, the like, and/or combinations thereof. Carpeted surface 92, or the like, may be attached on top surface 26 via hook and loop type fastener 94. Wherein carpeted surface 92 may be configured to be removable.

Referring now to FIGS. 2 and 4-9, in select embodiments of ergonomic elevated foot board device 10, elevating members 60 may include left side elevating member 96 and right side elevating member 102. Left side elevating member 96 may be affixed on bottom side 98 of platform structure 58 approximate left side 100 of platform structure 58. Right side elevating member 102 may be affixed on bottom side 98 of platform structure 58 approximate right side 104 of platform structure 58. Wherein, left side elevating member 96 and right side elevating member 102 may include height 106. Height 106 of left side elevating member 96 and right side elevating member 102 may be configured to elevate platform structure 58 to elevated position 36. Height 106 may be any desired height for providing elevated position 36 of platform structure 58 at any desired height. In select embodiments, height 106 of left side elevating member 96 and right side elevating member 102 may be, but is clearly not limited thereto, approximately 2 inches configured to elevate the platform structure approximately 2 inches. In select embodiments, left side elevating member 96 and right side elevating member 102 may each be a 2 inch by 2 inch square aluminum tube 108 with plastic end caps 110 on each end (like for appearance and/or safety).

Still referring to FIGS. 2 and 4-9, one feature of ergonomic elevated foot board device 10 may be the inclusion of base protectors 114. Base protectors 114 may be on bottom portion 116 of left side elevating member 96 and right side elevating member 102. Base protectors 114 may be configured to provide barrier 118 between elevating members 60 and floorboard 22 and may be configured to protect floorboard 22 from damage, like scratches, scuffs, dents, the like, etc. Base protectors 114 may be any devices, mechanisms, or combinations thereof configured to provide barrier 118 between elevating members 60 and floorboard 22. In select embodiments, base protectors 114 may be, but are not limited to, ribbed rubber stripping 120, like as shown in the Figures. Wherein, in select embodiments, ribbed rubber stripping 120 may be self-adhering or may be permanently affixed, like with commercial grade adhesive 82, or the like, to bottom portion 116 of elevating members 60.

Still referring to FIGS. 2 and 4-9, in select embodiments of ergonomic elevated foot board device 10, elevating members 60 may include at least one bracing member 122. The at least one bracing member 122 may be between left side elevating member 96 and right side elevating member 102. The at least one bracing member 122 may be configured to reinforce and stabilize platform structure 58 on elevating members 60. In select embodiments, the at least one bracing member may include front cross member 124, rear cross member 126, and interconnecting member 128. Front cross member 124 may be positioned approximate front side 34 of main base 24. Rear cross member 126 may be positioned approximate back side 30 of main base 24. Interconnecting member 128 may be interconnected between front cross member 124 and rear cross member 126. In select embodiments, first extension member 130 and second extension member 134 may be included. First extension member 130 may extend from rear cross member 126 on first side 132 of first cutout 28. Second extension member 134 may extend from rear cross member 126 on second side 136 of first cutout 28. In select embodiments, each of the at least one bracing members 122 may be, but are not limited to, one inch by one inch square aluminum tube 138 with caps 140 on any open ends 142 (like for appearance and/or safety).

Referring now to FIGS. 1, 4, 5, 6, 7, 9 and 10, another feature of ergonomic elevated foot board device 10 may be the inclusion of handle 144. Handle 144 may be configured to be used to carry ergonomic elevated foot board device 10, like for transporting ergonomic elevated foot board device 10 on and off of vehicle 12. In select embodiments, handle 144 may be positioned on outside side 146 of main base 24, like on outside side 146 of left side elevating member 96 or right side elevating member 102.

In another aspect, the present disclosure embraces the disclosed ergonomic elevated foot board device 10 in any of the various embodiments and/or combination of embodiments shown and/or described herein.

In sum, the purpose of the disclosed ergonomic elevated foot board device 10 may be to minimize the potential for foot/ankle soreness when operating vehicle 12 with floor mounted brake and/or accelerator pedals 38. Ergonomic elevated foot board device 10, as disclosed herein, may provide the driver with solid footing across the immediate floor area, as opposed to an item placed strictly in front of the accelerator/brake pedals. The platform structure 58 can either be covered with a thick rubber-like surface, sprayed a specified color, custom fitted with commercial-grade carpet/thick rubber matting, and/or the like, as desired. The ergonomic elevated foot board device 10, as disclosed herein, may be a new tool for drivers of vehicles with floor mounted pedals, like motorcoaches, buses, trucks, the like, etc. The ergonomic elevated foot board device 10, as disclosed herein, may cover an area approximately 2×2 feet. The ergonomic elevated foot board device 10, as disclosed herein, may be specifically cut to the dimensions of the floorboard area, so as not to impede with the safe operation of the vehicle. The ergonomic elevated foot board device 10 may essentially be wedged between the steering column 20 and the seat base mount 16.

The most important purpose behind the disclosed ergonomic elevated foot board device 10 is the overall comfort that should be realized by any driver. The design of the disclosed ergonomic elevated foot board device 10 may be configured to allow the driver to maintain a fixed foot/heel position, and fluidly maneuver between the accelerator/brake pedals. This may negate the need to “find” the pedals while driving. This in turn results in any commercial vehicle/vehicle being operated more smoothly. The disclosed ergonomic elevated foot board device 10 can either be permanently attached or swapped from one vehicle to another with relative ease. The instant ergonomic elevated foot board device 10 is not so limited to an add on foot board device for vehicles. As such, the instant disclosure contemplated vehicle manufactures creating vehicles with the foot board device permanently fixed in the vehicle (i.e. a raised floor board), or the vehicle manufacturers may create ergonomic foot board devices that are movably positioned under the driver's feet, like hinging or sliding into position.

The disclosed ergonomic elevated foot board device 10 could be made of wood, aluminum or plastic. The plastic could be a heavy-duty plastic (polyethylene). This heavy-duty plastic could allow the device to be made at a lower cost with less materials needed to be added on, etc. The platform dimensions would remain the same, regardless of material. The heavy-duty plastic material could be manufactured in the requested color, including, but not limited to, black. With the device made out of heavy-duty plastic material, the top surface may be composed of a grip-like material, thus, negating the need to be coated and/or sprayed. The elevating members 60 beneath the platform could be of various heights, and can be secured with mechanical fasteners, like heavy duty screws/bolts. The screws/bolts could be countersunk to allow for a smooth finish overall. This would allow the user to select which unit best suits their vehicle height-wise. Thick-rubber base protectors 114 could be used to protect the floorboard 22. The heavy-duty plastic embodiments may negate the need for a heel rest for the carpet, as this is counterproductively raising the foot too high. The heavy-duty plastic embodiments may negate the need for rubber edge guards 76, as the surface would be machined to a smooth finish. The heavy-duty plastic embodiments may also include carpeted surface 92 if desired.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. An ergonomic elevated foot board device for a vehicle including a driver's seat with a seat base mount, a steering wheel with a steering column, and a floorboard under the driver's seat and the steering column, the ergonomic elevated foot board device comprising:
a main base with a top surface;
the main base including a first cutout on a back side of the main base, the first cutout is configured to fit around the seat base mount of the driver's seat of the vehicle;
the main base including a second cutout on the front side of the main base, the second cutout is configured to fit around the steering column of the steering wheel of the vehicle; and
wherein, when the main base is positioned in between the driver's seat and the steering column of the vehicle with the first cutout around the seat base mount and the second cutout around the steering column, the ergonomic elevated foot board device is configured to position the top surface at an elevated position above the floorboard between the driver's seat and the steering column.

2. The ergonomic elevated foot board device of claim 1 being designed and configured to minimize foot or ankle soreness of a driver when operating a floor mounted pedal in the vehicle.

3. The ergonomic elevated foot board device of claim 1, wherein:
the first cutout including a first width, the first width is sized to receive the seat base mount therein; and
the second cutout including a second width, the second width is configured to receive the steering column therein.

4. The ergonomic elevated foot board device of claim 1, wherein:
the first cutout including a first depth;
the second cutout including a second depth;
the main base including a length from the front side to the back side;
the main base including a cutout distance from a first end of the first cutout at the first depth to a second end of the second cutout at the second depth; and
the cutout distance is approximate to a driver's foot area distance between the seat base mount and the steering column.

5. The ergonomic elevated foot board device of claim 1, wherein the main base including:
a platform structure with the top surface thereon; and
elevating members positioned under the platform structure, the elevating members are configured to elevate the platform structure from the floorboard of the vehicle and to serve as a foundation of the platform structure on the floorboard.

6. The ergonomic elevated foot board device of claim 5, wherein the platform structure including the first cutout on the back side of the main base and the second cutout in the front side of the main base.

7. The ergonomic elevated foot board device of claim 6, wherein the platform structure further including a pedal notch on the front side of the main base; and
wherein, when the main base is positioned in between the driver's seat and the steering column of the vehicle with the first cutout around the seat base mount and the second cutout around the steering column, the pedal notch is configured to be positioned approximate a floor mounted pedal.

8. The ergonomic elevated foot board device of claim 5, wherein the platform structure is made from a wood material, a sheet metal material, or a hard plastic material, wherein:
the sheet metal material is a 16-guage aluminum sheet metal material approximately 2 feet by 2 feet; or
the hard plastic material is a polyethylene material.

9. The ergonomic elevated foot board device of claim 8, wherein the platform structure including an edge guard around a perimeter of the platform structure, the edge guard being a rubber guard positioned on the perimeter of the platform structure; and
wherein, the edge guard is form-fitting on the perimeter of the platform structure, or the edge guard is permanently affixed with a commercial grade adhesive.

10. The ergonomic elevated foot board device of claim 5, wherein the top surface of the platform structure including:
a rubber grip surface on the top surface;
a coated or sprayed grip on the top surface;
a textured surface being the top surface;
a padded heel rest on the top surface;
a carpeted surface attached on the top surface via a hook and loop type fastener, wherein the carpeted surface is configured to be removable; and
combinations thereof.

11. The ergonomic elevated foot board device of claim 5, wherein the elevating members including:
a left side elevating member affixed on a bottom side of the platform structure approximate a left side of the platform structure;
a right side elevating member affixed on the bottom side of the platform structure approximate a right side of the platform structure; and
wherein the left side elevating member and the right side elevating member including a height, wherein the height of the left side elevating member and the right side elevating member being configured to elevate the platform structure to the elevated position.

12. The ergonomic elevated foot board device of claim 11, wherein:
the height of the left side elevating member and the right side elevating member being approximately 2 inches configured to elevate the platform structure approximately 2 inches; or
the left side elevating member and the right side elevating member are each a 2 inch by 2 inch square aluminum tube with plastic end caps on each end.

13. The ergonomic elevated foot board device of claim 11, wherein the left side elevating member and the right side elevating member including base protectors on a bottom portion of the elevating members, the base protectors are configured to provide a barrier between the elevating members and the floorboard configured to protect the floorboard from damage.

14. The ergonomic elevated foot board device of claim 13, wherein the base protectors are ribbed rubber stripping, wherein the ribbed rubber stripping is self-adhering or is permanently affixed with commercial grade adhesive to the bottom portion of the elevating members.

15. The ergonomic elevated foot board device of claim 11, wherein the elevating members including at least one bracing member between the left side elevating member and the right side elevating member, the at least one bracing member is configured to reinforce and stabilize the platform structure on the elevating members.

16. The ergonomic elevated foot board device of claim 15, wherein:
the at least one bracing member including:
a front cross member positioned approximate the front side of the main base;
a rear cross member positioned approximate the back side of the main base;
an interconnecting member interconnected between the front cross member and the rear cross member;
a first extension member extending from the rear cross member on a first side of the first cutout;
a second extension member extending from the rear cross member on a second side of the first cutout; and
wherein, each of the at least one bracing member is a one inch by one inch square aluminum tube with caps on any open ends.

17. The ergonomic elevated foot board device of claim 1 further comprising a handle, the handle being configured to be used to carry the ergonomic elevated foot board device, wherein the handle is positioned on an outside side of a left side elevating member or a right side elevating member.

18. The ergonomic elevated foot board device of claim 1 being configured for a motorcoach, a bus, or a truck.

19. An ergonomic elevated foot board device for a vehicle with a driver's seat, a steering wheel, and a floorboard under the driver's seat and the steering wheel, the ergonomic elevated foot board device comprising:
a main base with a top surface, the main base including:
a platform structure with the top surface thereon;
elevating members positioned under the platform structure, the elevating members are configured to elevate the platform structure from the floorboard of the vehicle and to serve as a foundation of the platform structure on the floorboard; and
wherein, when the main base is positioned on the floorboard, the ergonomic elevated foot board device is configured to position the top surface at an elevated position above the floorboard.

20. An ergonomic elevated foot board device for a vehicle including a driver's seat with a seat base mount, a steering wheel with a steering column, and a floorboard under the driver's seat and the steering column, the ergonomic elevated foot board device comprising:
a main base with a top surface;
the main base including a first cutout on a back side of the main base, the first cutout is configured to fit around the seat base mount of the driver's seat of the vehicle, the first cutout including a first width and a first depth, the first width is sized to receive the seat base mount therein;
the main base including a second cutout on the front side of the main base, the second cutout is configured to fit around the steering column of the steering wheel of the vehicle, the second cutout including a second width and a second depth, the second width is sized to receive the steering column therein;
the main base including a length from the front side to the back side;
the main base including a cutout distance from a first end of the first cutout at the first depth to a second end of the second cutout at the second depth, the cutout distance is approximate to a driver's foot area distance between the seat base mount and the steering column;
a platform structure with the top surface thereon, wherein the platform structure including the first cutout on the back side of the main base and the second cutout in the front side of the main base, wherein the platform structure is made from a wood material, a sheet metal material, or a hard plastic material;
wherein the platform structure including an edge guard around a perimeter of the platform structure, the edge guard being a rubber guard positioned on the perimeter of the platform structure;
wherein the top surface of the platform structure including:
a rubber grip surface on the top surface;
a coated or sprayed grip on the top surface;
a textured surface being the top surface;
a padded heel rest on the top surface;
a carpeted surface attached on the top surface via a hook and loop type fastener, wherein the carpeted surface is configured to be removable; and
combinations thereof
elevating members positioned under the platform structure, the elevating members are configured to elevate the platform structure from the floorboard of the vehicle and to serve as a foundation of the platform structure on the floorboard, wherein the elevating members including:
a left side elevating member affixed on a bottom side of the platform structure approximate a left side of the platform structure;
a right side elevating member affixed on the bottom side of the platform structure approximate a right side of the platform structure;
at least one bracing member between the left side elevating member and the right side elevating member, the at least one bracing member is configured to reinforce and stabilize the platform structure on the elevating members;
wherein the left side elevating member and the right side elevating member including a height, wherein the height of the left side elevating member and the right side elevating member being configured to elevate the platform structure to an elevated position;
wherein the left side elevating member and the right side elevating member including base protectors on a bottom portion of the elevating members, the base protectors are configured to provide a barrier between the elevating members and the floorboard configured to protect the floorboard from damage, wherein the base protectors are ribbed rubber stripping;
a handle being configured to be used to carry the ergonomic elevated foot board device, wherein the handle is positioned on an outside side of the left side elevating member or the right side elevating member;
wherein, when the main base is positioned in between the driver's seat and the steering column of the vehicle with the first cutout around the seat base mount and the second cutout around the steering column, the ergonomic elevated foot board device is configured to position the top surface at the elevated position above the floorboard between the driver's seat and the steering column;
wherein, the ergonomic elevated foot board device is designed and configured to minimize foot or ankle soreness of a driver when operating a floor mounted pedal in the vehicle; and
wherein, the ergonomic elevated foot board device is configured for a motorcoach, a bus, or a truck.
